(19) United States
(12) Patent Application Publication
(10) Pub. No.: US 2009/0144052 A1
(43) Pub. Date: Jun. 4, 2009

(54) METHOD AND SYSTEM FOR PROVIDING CONVERSATION DICTIONARY SERVICES BASED ON USER CREATED DIALOG DATA

(75) Inventors: Tae Hoon LEE, Seongnam (KR); Sung Won CHOI, Seoul (KR); Chiyung AHN, Seoul (KR); Jae Young LEE, Seoul (KR)

Correspondence Address: EDWARDS ANGELL PALMER & DODGE LLP, P.O. BOX 55874, BOSTON, MA, 02205, US

(73) Assignee: NHN CORPORATION, Seongnam (KR)

(21) Appl. No.: 12/234,774

(22) Filed: Sep. 22, 2008

(30) Foreign Application Priority Data
Dec. 4, 2007 (KR) 10-2007-0125166

(51) Int. Cl. G06F 17/21; G06F 17/30

(52) U.S. Cl. 704/10; 707/3; 707/E17.001

(57) ABSTRACT

A method for providing a conversation dictionary service includes the steps of: (a) receiving a request for editing conversation expressions from a user; (b) providing the user with a format page for editing the expressions; (c) creating expression data by connecting the information inputted in a conversation entry window and a situation entry window with identification information on the user; and (d) recording the expression data in an expression database. The service can make a user edit conversation expressions and expanding the coverage of the conversation expressions, thereby providing more various examples reflecting the newly or uniquely used conversation expressions in a daily life.

### CROSS-REFERENCE TO RELATED APPLICATION

This application claims under 35 U.S.C. §119(a) the benefit of Korean Patent Application No. 10-2007-0125166 filed Dec. 4, 2007, the entire contents of which are incorporated herein by reference.

### TECHNICAL FIELD

The present invention relates to a method and a system for providing a conversation dictionary expandable by user(s). More particularly, it relates to a method and a system for providing user-convenient conversation dictionary services, which can provide at the request of a user a search result page or pages including conversation information retrieved from a conversation database and offer an editor to enable the user to correct or revise the page or pages.

### BACKGROUND ART

A number of portals provide dictionary services. Dictionary service providers offer users not only search results for words and/or idioms but also conversation phrases and expressions including such words and/or idioms.

The conventional methods of providing dictionary services, however, have drawbacks. For example, conversation phrases and expressions provided to users are limited those which have been made by dictionary makers and it is difficult to reflect new and/or unique phrases and expressions created in a daily life by individuals.

The above information disclosed in this Background Art section is only for enhancement of understanding of the background of the invention and therefore it may contain information that does not form the prior art that is already known in this country to a person of ordinary skill in the art.

### SUMMARY

It is, therefore, an object of the present invention to provide a method and a system for providing dictionary services that enable a user to edit phrases and expressions, thereby providing more various phrases and expressions including those which are newly or uniquely used in a daily life.

In accordance with one aspect of the present invention, there is provided a system for providing conversation dictionary services including: an expression database for storing at least one conversation expression, information about identification of at least one user who creates the expression, and information about situation related to the expression; an expression search part for retrieving from the expression database a specific expression that meets a search term inputted by a certain user; a result page creating part for creating a result page to be provided to the certain user by using the specific expression received from the expression search part; and an expression editing part for creating an expression to be stored in the expression database by directly inputting the expression or editing an expression which has been recorded in the expression database. In this case, the expression editing part includes: an expression creating part for providing the certain user with a format page which enables the certain user to input the expression to be stored in the expression database or edit the expression which has been recorded in the expression database, the format page including a conversation entry window in which contents of the conversation included in the expression to be stored in the expression database is inputted and a situation information entry window in which the situation information may be inputted; a category management part for connecting information inputted in the situation information entry window with information inputted in the conversation entry window; and an expression storage part in which the information inputted in the format page is stored with identification information on the certain user.

In accordance with another aspect of the present invention, there is provided a method for providing a conversation dictionary service including the steps of: (a) receiving a request for editing conversation expressions from a user; (b) providing the user with a format page for editing the expressions at the request of the edition, the format page including a conversation entry window in which contents of the conversation to be included in the expression are inputted and a situation information entry window in which situation information is inputted; (c) creating expression data by connecting the information inputted in the conversation entry window and the situation entry window with identification information on the user; and (d) recording the expression data in an expression database.

The above and other features will be discussed infra.

### BRIEF DESCRIPTION OF THE DRAWINGS

The above and other objects and features of the present invention will become apparent from the following description of preferred embodiments given in conjunction with the accompanying drawings, in which:

FIG. 1 shows the configuration of a conversation dictionary system in accordance with a preferred embodiment of the present invention.

FIG. 2 represents the screen of a user terminal in which the user can create phrases and expressions.

FIGS. 3A and 3B illustrate a process for retrieving conversation phrases and expressions by using a search term and selecting a part of the retrieved result for further search.

FIGS. 4A and 4B illustrate the screen of a user terminal which displays conversation phrases and expressions retrieved from a phrase and expression database.

### DETAILED DESCRIPTION OF THE PREFERRED EMBODIMENTS

The detailed description of the present invention illustrates specific embodiments in which the present invention can be performed with reference to the attached drawings.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The term “expressions” herein is used to include phrases and idioms, unless it is indicated otherwise.

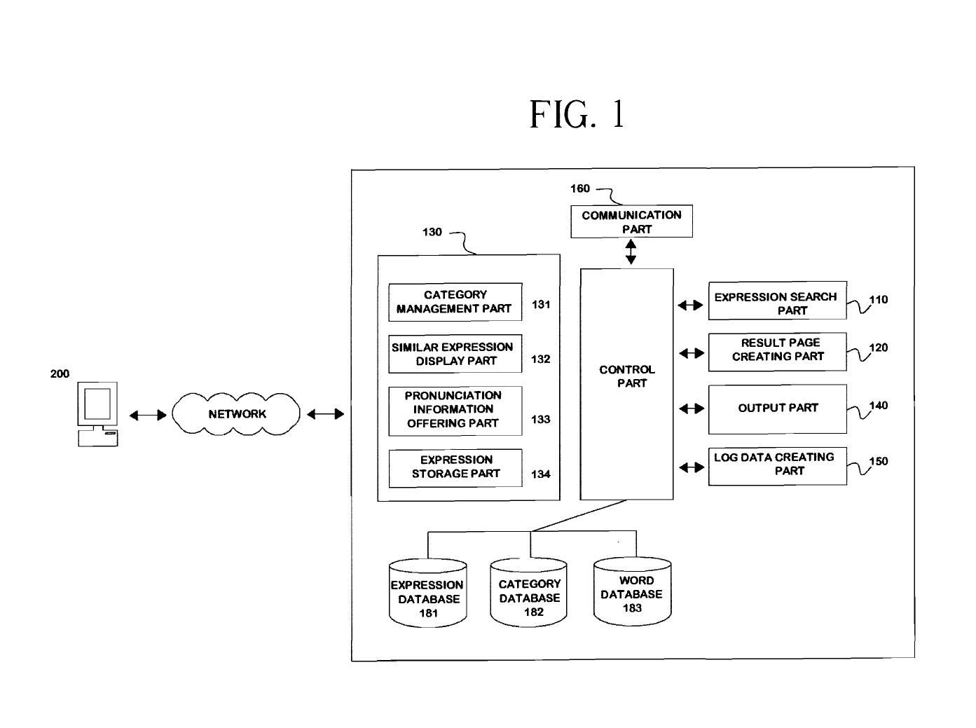

FIG. 1 shows the configuration of a conversation dictionary system in accordance with a preferred embodiment of the present invention.

As illustrated in FIG. 1, the conversation dictionary system according to a preferred embodiment of the present invention includes an expression search part 110, a result page creating part 120, an expression editing part 130, an output part 140, a log data creating part 150, a communication part 160, a control part 170 and databases 181-183.

The expression search part 110 may search data in an expression database 181 and/or a word database 183 to retrieve information that meets a search term and transmit the retrieved information, e.g., conversation phrases and expressions etc. to the result page creating part 120.

The result page creating part 120 may create, by using the information transmitted from the expression search part 110, a search result page to be provided to a user terminal 200.

The expression editing part 130 may provide an editor for a user to edit new or existing conversation phrases and expressions. The expression editing part 130 may, preferably, include a category management part 131, a similar expression display part 132, a pronunciation information offering part 133 and an expression storage part 134.

The category management part 131 may classify conversation phrases and expressions into categories under a certain standard and manage the classified conversation phrases and expressions. For example, it may classify conversation phrases and expressions by situation related to a conversation phrase/expression (e.g., a place where such a conversation is made or a main topic of the conversation). It may obtain situation information inputted by a user. Alternatively, it may recommend appropriate situation information from situation information already stored in the category database 182. The situation information is tag information representing properties of the conversation phrases and expressions and may be stored with the corresponding conversation phrases and expressions in the expression database 181. The category database 182 may include various situation information provided by the conversation dictionary system of the present invention.

The similar expression display part 132 may receive a search term from a user who desires to edit a conversation phrase/expression, transmit the search term to the expression search part 110, and display through the user terminal 200 the phrases and expressions obtained by the expression search part 110, in case the similar expression display part 132 receives a request by the user for conversation phrases and expressions prepared by other users.

The pronunciation information offering part 133 may automatically recommend appropriate pronunciation information to a user when the user inputs phrases or expressions or receive pronunciation information from a user.

The expression storage part 134 may store in the expression database 181 the conversation phrases and expressions edited by a user.

The output part 140 may allow a part or whole of the conversation phrases and expressions recorded in the expression database 181 to be printed in a paper, encoded into a renewable digital file format such as mp3, or converted into a computer file such as Excel or Word file. It enables a user to study thus-selected conversation phrases and expressions offline.

The log data creating part 150 may create a log containing information on the track of a user in the conversation dictionary system.

The communication part 160 may help the conversation dictionary system communicate with external systems such as the user terminal 200.

The control part 170 may control the data flow among the expression search part 110, the result page creating part 120, the expression editing part 130, the output part 140, the log data creating part 150 and the databases 181-183. In other words, the control part 170 may enable the expression search part 110, the result page creating part 120, the expression editing part 130, the output part 140, the log data creating part 150 and the databases 181-183 to carry out their respective functions by controlling signals transmitted and received among the modules.

The databases in the present invention may contain databases not only in a narrow sense but also in a broad sense including data records based on file systems. Further, a set of simple logs can fall within the databases as long as the logs can be retrieved and extracted.

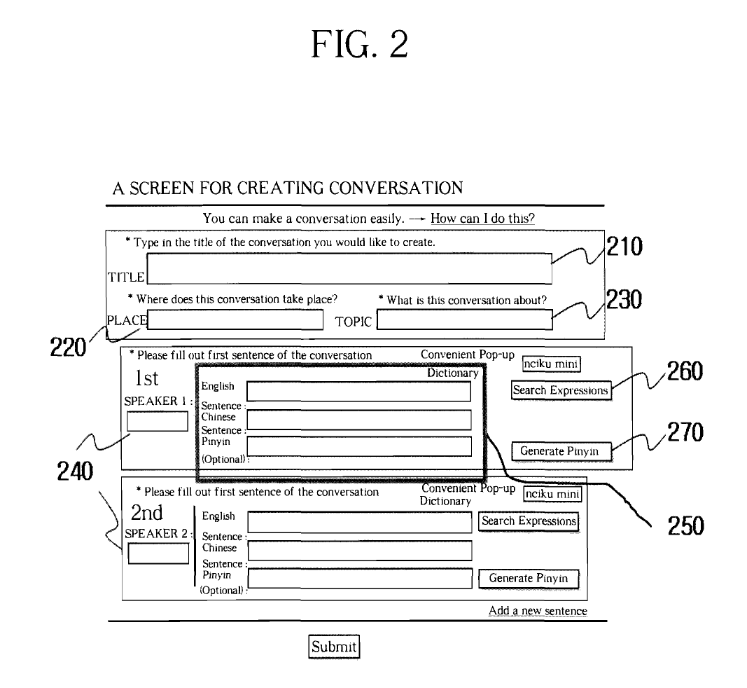

FIG. 2 represents the screen of a user terminal in which the user can create phrases and expressions.

A user may insert information about title or situation (e.g., a place or topic) of a conversation phrase or expression the user wants to create. For example, as shown in FIG. 2, the user may insert a title of a conversation phrase or expression in a title entry window 210, a place thereof in a place entry window 220 and a topic thereof in a topic entry window 230. In one embodiment, the situation information may be obtained and designated from property data of the conversation phrases and expressions. For example, the place information, e.g., “bank”, may correspond to the topic information, e.g., “Exchange money”, “Report the loss”, “Draw money.” Although the embodiment illustrates a place and a topic as situation information, it should be noted that situation information may not be limited to a place and a topic and it may include other information (e.g., relationship between speakers).

In accordance with one example embodiment of the present invention, a user may use an input device such as a keyboard to input the information on the place and the topic related to the conversation in the place entry window 220 and the topic entry window 230, respectively.

In accordance with another example embodiment of the present invention, the category management part 131 may analyze titles inputted in the title entry window 210 and/or contents of the conversation inputted in a conversation entry window 250 to automatically designate or recommend an appropriate place or an appropriate topic. Preferably, for example, a main character string or strings may be extracted from the title and the conversation phrases and expressions and then the information on the place and the topic corresponding to the extracted main character string or strings may be retrieved from the category database 182. In the category database 182, typical or representative situation information provided by the conversation dictionary system of the present invention is classified under a preset standard and stored.

The main character strings can be extracted from the text information by using any method known in the art such as a natural language processing scheme and a morphological analysis scheme.

A user may create a conversation phrase or expression by inputting the identity of speakers and conversation contents in a speaker entry window 240 and the conversation entry window 250 respectively. Although FIG. 2 shows three items are inputted in the conversation entry window 250, a variety of information may be inputted in the conversation entry window 250. For example, if an American wants to create data to be used to study Chinese conversation, he or she may input English sentences, Chinese sentences corresponding to the English sentences, and pronunciation symbols of the Chinese sentences etc.

A similar expression search button 260 may carry out the function to provide a user with the information corresponding to the sentences inputted by the user. For instance, if an American user wants to create the data available to learn Chinese conversation, the similar expression display part 132 may offer the user with Chinese phrases and expressions including the texts whose meanings are similar to those of English texts inputted by the user by referring to the expression database 181 and then the American user can select or edit at least a part of them, saving user's time and energy in creating the Chinese expressions.

A pronunciation symbol creation button 270 may automatically create pronunciation symbols corresponding to a phrase or expression inputted by a user. This function may, suitably, be carried out such that the pronunciation information offering part 133 retrieves word data included in the phrase or expression from the word database 183 and then extracts the information on the pronunciation symbols from the retrieved data.

The phrase or expression created as described above may be stored in the expression database 181 with the information on the identification of the user who has created the expression so that the created expression can be shared with other users. As such, conversation database(s) can be built by participation of users.

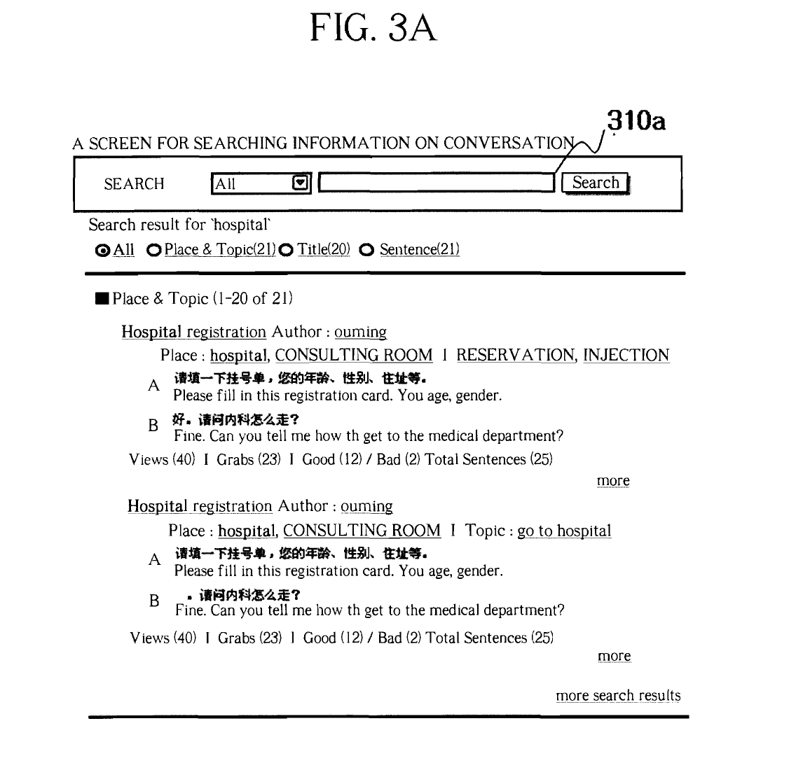

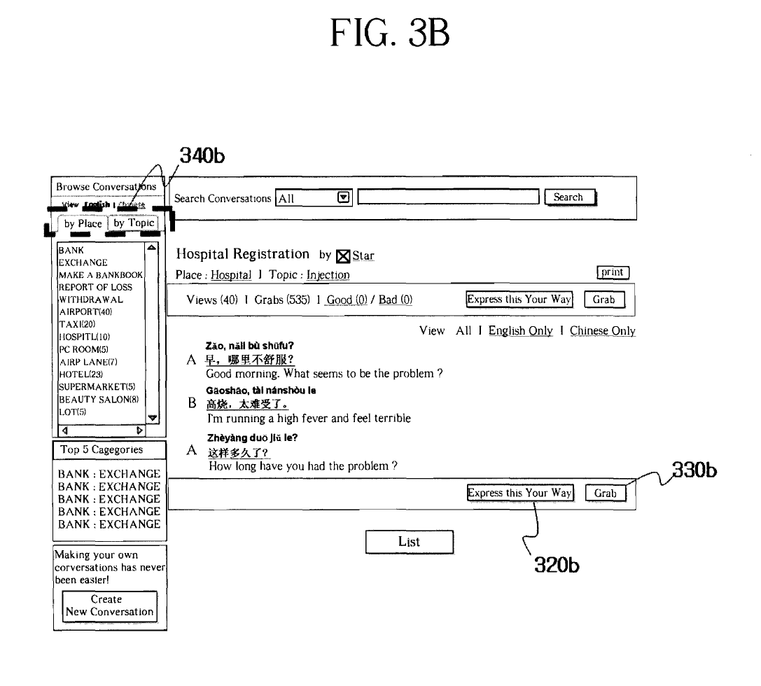

A process for editing the conversation phrases and expressions may be carried out by inquiring the conversation phrases and expressions included in the expression database 181 and revising them by the user. FIGS. 3A and 3B illustrate a process for retrieving conversation phrases and expressions by using a search term and selecting a part of the retrieved result for further search.

As shown in FIG. 3A, a user may input search term or terms in a search window 310a in order to conduct search for data recorded in the expression database 181. The expression search part 110 may retrieve appropriate data from the expression database 181 by using the inputted search term or terms and then extract expression data that meets the search term or terms with regard to a title, a place, a topic etc. The result page creating part 120 may arrange the extracted expression data by a particular standard and then provide them to the user terminal 200.

In addition, as shown in the field 340b of FIG. 3B, a user may search the expression data to which particular situation information has been designated by selecting the particular situation information stored in the category database 182. It should, however, be noted that this is not limited to an exemplary screen shown in FIG. 3B. The thus-searched expression data may be displayed on the right side of the field 340b as shown in FIG. 3B.

On the other hand, as illustrated in the field 340b of FIG. 3B, appropriate situation information may be selected from a list. Alternatively, a user, while searching a specific word recorded in the word database 183, may click the specific word to search phrase and expression data to which the specific word is designated as its situation information provided the specific word corresponds to situation information (e.g., a place or a topic) included in the category database 182.

Moreover, by referring to FIG. 3B, when the user clicks an “Express this Your Way” button 320b, the user can get the screen of FIG. 2 to carry out the edition of the expression data.

If the user edits pre-stored expression data, the phrase or expression that the user inquired in detail may be filled in at least one of the title entry window 210, the place entry window 220, the topic entry window 230, the speaker entry window 240 and the conversation entry window 250, unlike the screen in FIG. 2. In other case, the title entry window 210, the place entry window 220 and the topic entry window 230 may be deactivated and provided to the user. In this manner, users may revise, to their tastes, the pre-stored conversation phrases and expressions in the expression database 181, which may result in the conversation dictionary capable of reflecting more various phrases and expressions.

When a user clicks a “Grab” button 330b of FIG. 3B, the user can store corresponding phrases and expressions in his or her own dictionary without having to performing a separate editing procedure.

While the expression data are provided as shown in FIGS. 3A and 3B, if a mouse pointer etc. is located at a part of the provided expression data, corresponding letters located at the mouse pointer may be enlarged or the pronunciation of the corresponding letters may be replayed. The above-mentioned user friendly interface may be implemented by appropriately using the well-known programming techniques such as AJAX (Asynchronous Javascript and XML), Javascript and Flash.

According to an embodiment, if the conversation phrases and expressions that are directly inputted, or created by editing phrase and expression data of other persons, or created by using the phrase and expression data of other persons without editing are stored in the expression database 182, such phrases and expressions may be stored in linkage with identification information of a user who stores them. The identification information may be used not only to indicate the information on the author of the expression data but also to refer later to the examples created, edited or stored by the user, thereby implementing the function of a customized conversation dictionary.

The output part 140 may receive information on at least a part of the phrase and expression data selected by the user among the phrase and expression data recorded in the expression database 181 and then print out the selected phrase and expression data on a paper or in a form of file.

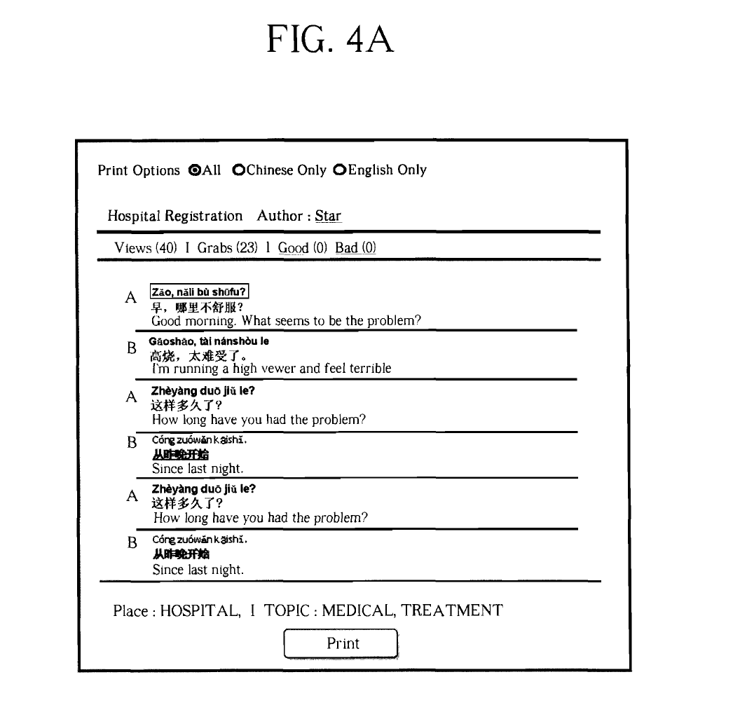

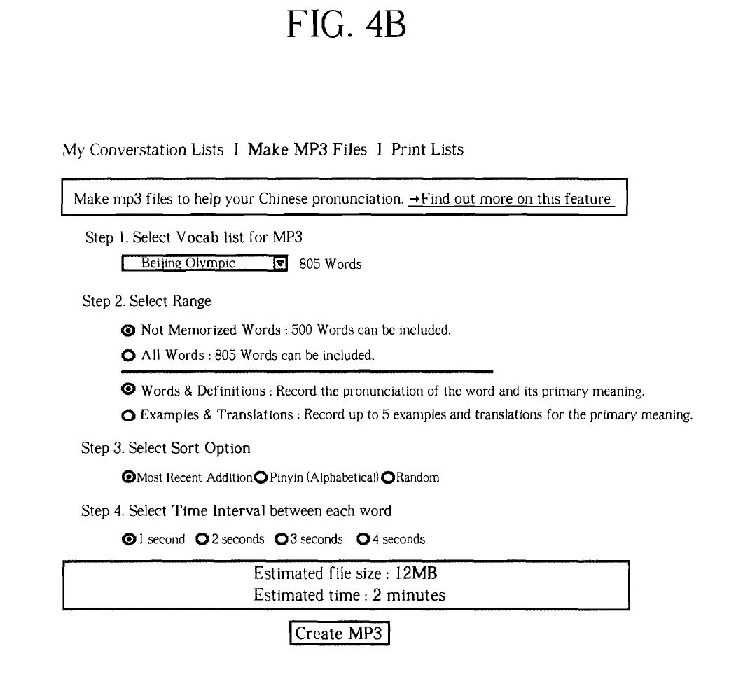

FIG. 4A shows an exemplary service screen on which a user can create his or her conversation notepad by enabling the user to print out at least a part of the examples stored in the expression database 181.

By referring to FIG. 4A, it can be seen that each of conversation phrases and expressions shows its meaning in English and even its pronunciation symbol. Therefore, it allows a user to edit and choose certain phrases and expressions for his or her own taste and then create the conversation notepad by using the certain phrases and expressions, which may result in an effective memory of the user.

FIG. 4B illustrates a service screen for printing out at least a part of expressions stored in the expression database 181 into a file format playable by audio devices such as an MP3 file.

FIG. 4B shows the creation of the audio files etc. by appropriately selecting options such as a scope of the conversation expressions, a file size, and a time interval between the conversation expressions to create the MP3 file.

In accordance with the present invention, a user may edit the conversation phrases and expressions to suit individual preference and generate a conversation dictionary with improved functions; and other users may use such a conversation dictionary to create another conversation dictionary. Thus, the conversation phrases and expressions edited by the users may be used to expand the coverage of the conversation information. In addition, in accordance with the present invention, the effects to build a conversation dictionary database alive may be achieved by reflecting a variety of words used in a real life.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case.

While the invention has been shown and described with respect to the preferred embodiments, it will be understood by those skilled in the art that various changes and modification may be made without departing from the spirit and scope of the invention as defined in the following claims.

Accordingly, the thought of the present invention must not be confined to the explained embodiments, and the following patent claims as well as everything including variations equal or equivalent to the patent claims pertain to the category of the thought of the present invention.

What is claimed is:

1. A system for providing conversation dictionary services comprising:
an expression database for storing at least one conversation expression, information about identification of at least one user who creates the expression, and information about situation related to the expression;
an expression search part for retrieving from the expression database a specific expression that meets a search term inputted by a certain user;
a result page creating part for creating a result page to be provided to the certain user by using the specific expression received from the expression search part; and
an expression editing part for creating an expression to be stored in the expression database by directly inputting the expression or editing an expression which has been recorded in the expression database,
wherein the expression editing part includes:
an expression creating part for providing the certain user with a format page which enables the certain user to input the expression to be stored in the expression database or edit the expression which has been recorded in the expression database, the format page including a conversation entry window in which contents of the conversation included in the expression to be stored in the expression database is inputted and a situation information entry window in which the situation information may be inputted;
a category management part for connecting information inputted in the situation information entry window with information inputted in the conversation entry window; and
an expression storage part in which the information inputted in the format page is stored with identification information on the certain user.

2. The system of claim 1, further comprising: a category database in which a list including the situation information is recorded; and
wherein the category management part recommends the certain user particular situation information selected among the list recorded in the category database.

3. The system of claim 1, wherein the situation information includes at least one of the following:
information on a place in which the conversation with the expression is made;
information on a topic of the conversation with the expression; and
information on a human relationship of which the conversation with the expression is made.

4. The system of claim 1, wherein the expression editing part further including:
a similar expression display part for providing information on other expressions similar to the contents of the conversation inputted in a dialog entry window by referring to the expression database.

5. The system of claim 4, wherein the similar expression display part offers similar expressions by referring to at least one of the information inputted in the conversation entry window and the situation information entry window.

6. The system of claim 1, further comprising:
an output part for outputting at least a part of the expressions stored in the expression database.

7. The system of claim 6, wherein the output part carries out at least one of the following functions:
to print out the expression in a paper;
to encode the expression into a playable audio data; and
to convert the expression into a file executable by an application program.

8. The system of claim 1, further comprising a word database for storing a word and its pronunciation symbol,
wherein the conversation entry window includes a pronunciation symbol entry window in which the certain user enters the pronunciation symbol of the conversation inputted therein; and
wherein the pronunciation symbol is provided to the certain user by extracting a specific pronunciation symbol in association with words included in the conversation entry window from the word database.

9. The system of claim 1, wherein the result page creating part includes a certain program code, which program code enlarges text data included in a particular region or converts the text data into audio signals to provide to the certain user if the particular region on the result page is selected by the certain user.

10. The system of claim 1, wherein the search term includes conditions related to the conversation information included in the expression and the situation information.

11. A method for providing conversation dictionary services comprising the steps of:
(a) receiving a request for editing conversation expressions from a user;
(b) providing the user with a format page for editing the expressions at the request of the edition, the format page including a conversation entry window in which contents of the conversation to be included in the expression are inputted and a situation information entry window in which situation information is inputted;
(c) creating expression data by connecting the information inputted in the conversation entry window and the situation entry window with identification information on the user; and
(d) recording the expression data in an expression database.

12. The method of claim 11, wherein the step (b) includes the steps of:
obtaining the pre-stored expression data from the expression database; and
combining at least a part of the expression data with the format page to provide the user.

13. The method of claim 11, wherein the situation information includes at least one of the following:
information on a place where the conversation is made;
information on a topic of the conversation;
information on a human relationship of which the conversation is made.

14. The method of claim 11, wherein the expression data stored in the expression database is inquired or revised by other users.

15. One or more computer-readable media having stored thereon a computer program that, when executed by one or more processors, causes the one or more processors to perform acts including:
receiving a request for editing conversation expressions from a user;
providing the user with a format page for editing the expressions at the request of the edition, the format page including a conversation entry window in which contents of the conversation to be included in the expression are inputted and a situation information entry window in which situation information is inputted;
creating expression data by connecting the information inputted in the conversation entry window and the situation entry window with identification information on the user; and
recording the expression data in an expression database.
